(19) United States
(12) Patent Application Publication
(10) Pub. No.: US 2022/0303299 A1
(43) Pub. Date: Sep. 22, 2022

(54) System for Determining Network Security of Connected Devices

(71) Applicant: Paul B. Barringer, II, Norwalk, CT (US)

(72) Inventor: Paul B. Barringer, II, Norwalk, CT (US)

(21) Appl. No.: 17/204,579

(22) Filed: Mar. 17, 2021

(51) Int. Cl. H04L 29/06

(52) U.S. Cl. CPC H04L 63/1433; H04L 63/1416; H04L 63/0876; H04L 63/20; H04L 63/0236

(57) ABSTRACT

A system for assessing security of network connected things is provided having a computer, a database of vulnerable device types in data communication with said computer, a plurality of things connected to the network, a plurality a connection requests sent to said plurality of things by said computer, a message received by said computer from at least one of said plurality of things in response to the connection request, software executing on said computer classifying at least one of said things as at least one device type based on said received message, and software executing on said computer comparing said at least one device type to said vulnerable device types to determine whether the device is vulnerable.

### TECHNICAL FIELD

The present invention relates to a novel system for determining network security of connected devices. Specifically, the system allows for identification and notification of vulnerable network-connected devices.

### BACKGROUND

Computer viruses and hackers have been known in the art for many years. Now with the increased number of Internet connected things, there is a larger emphasis and importance associated with securing Internet connected things.

Traditional means of securing computers from viruses and other malware threats are not tenable for the sheer number of connected devices today, many of which run embedded operating systems.

For example, many new cars are now connected to the Internet. Functions of the cars such as whether the engine is turned on or if the doors are unlocked can be controlled through smartphones. While this is touted as a feature by the car companies, there have been instances where hackers have been able to take control of a moving vehicle. Accordingly, there is a need to prevent a malicious actor from controlling motor vehicles, potentially in an unsafe manner.

These security concerns are not limited to cars, but to any computer connected system. Industrial control systems for dams, power generation and distribution facilities, oil and natural gas pipelines, etc., all face these concerns.

There is a desire in the art for a system that can identify vulnerable network connected things. There is also a desire in the art for notifying potentially interested parties of the vulnerability, such as the thing's owner or operator, or the owner or operator of the network to which the thing is connected. There is also a desire in the art to quarantine such vulnerable network connected things to prevent the spread of viruses and malware.

### SUMMARY

For these and other reasons known to a person of an ordinary skill in the art, what is needed is a system for determining network security of connected devices.

A goal of the present invention is to identify vulnerable network connected things.

Another goal of the present invention is to notify interested parties about the vulnerable network connected thing.

Another goal of the present invention is to quarantine or otherwise seclude the vulnerable network connected thing.

Another goal of the present invention is to stop the spread of malware and other undesirable programs from infecting and/or controlling network connected things.

In one aspect of the present invention, a system for assessing security of network connected things is provided having a computer, a database of vulnerable device types in data communication with said computer, a plurality of things connected to the network, a plurality a connection requests sent to said plurality of things by said computer, a message received by said computer from at least one of said plurality of things in response to the connection request, software executing on said computer classifying at least one of said things as at least one device type based on said received message, and software executing on said computer comparing said at least one device type to said vulnerable device types to determine whether the device is vulnerable.

### BRIEF DESCRIPTION OF THE DRAWINGS

FIG. 1 shows a schematic diagram of the presently disclosed system.

### DETAILED DESCRIPTION

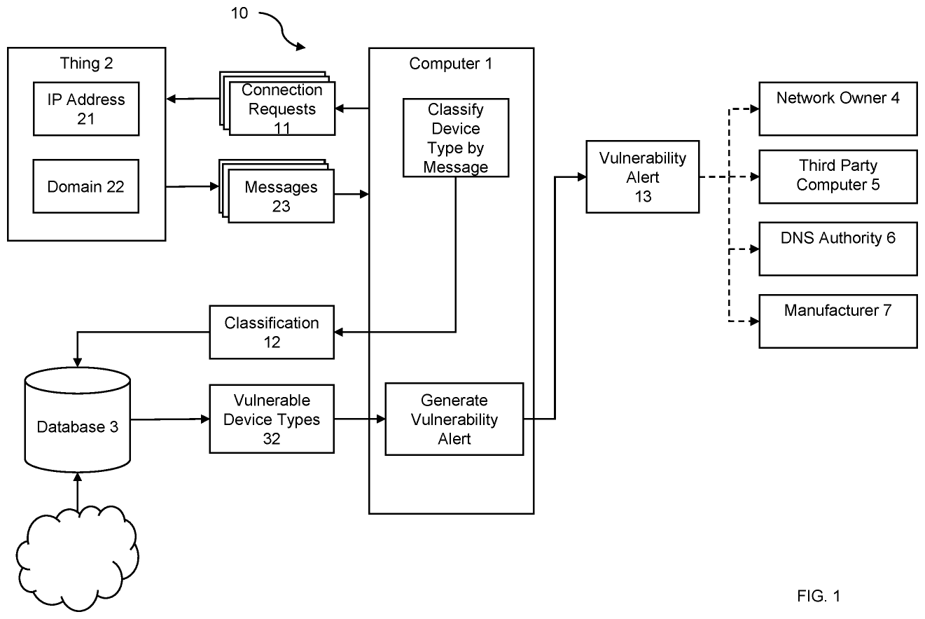

Referring to FIG. 1, the present disclosure describes a system 10 for Determining network security of connected devices.

The system 10 includes a computer 1. The computer 1 may be a processor, remote computer, computer server, network, or any other computing resource.

The computer 1 may be in data communication with at least one thing 2. The at least one thing 2 may be a computer, laptop, smartphone, tablet, or other electronic device, capable of transmitting data to the computer 1. The at least one thing 2 may also be a computer or processor embedded in a car, refrigerator, lightbulb, industrial control system, etc. Each thing 2 may have at least one IP address 21. Each thing 2 may be associated with a domain 22.

The computer 1 may send a connection request 11 to the at least one thing 2. The connection request 11 may be generated using banner grabbing software. The computer 1 may receive a message 23 from the thing 2 in response to the connection request 11. The message 23 may be a request header, such as a HTTP request header.

The computer 1 may classify the thing 2 as a device type based on the message 23. The classification may be made based on at least one of the operating system of the thing 2, a software version of the thing 2, a communication protocol used by the thing 2, or any other known means of determining advice type for the thing 2 from the message 23.

The computer 1 may also be in communication with a database 3. The database 3 may be a storage drive or array accessible to computer 1, or cloud storage. The database 3 may store information regarding the system 10. The database 3 may store a list of query-able vulnerable device types. The database 3 may receive updates to the list over the Internet.

The computer one may send the classification 12 as a query to the database 3. The database 3 may return an indication of whether the classification 12 is of a vulnerable device type 32.

If a vulnerable device type is identified for a thing 2, the computer 1 may generate a vulnerability alert. The vulnerability alert 13 may be sent to one or several potential recipients. For example, the vulnerability alert may be sent to a network owner 4. The network owner 4 may own or operate the network to which the thing 2 is connected so they may take steps to rectify or isolate the vulnerability.

As another example, the vulnerability alert 13 may be sent to a third-party computer 5. The third-party computer 5 may be associated with, for example, an Internet service provider, a network security firm. The third-party computer 5 may use the vulnerability alert 13 to either quarantine rectify the issue with the thing 2, or alert the owner or operator of the thing 2 of the vulnerability.

As another example, the vulnerability alert 13 may be sent to a DNS authority 6. The DNS authority 6 may quarantine any domain name or IP address associated with the thing 2 based on the vulnerability alert 13.

As yet another example, the vulnerability alert 13 may be sent to the manufacturer 7 of the thing 2, who may, for example, be able to use the vulnerability alert 13 to address any software issues with their thing 2.

These examples of potential recipients of vulnerability alerts are not meant to be limiting, as a POSITA would understand there are many potential recipients.

Vulnerable in this context is not meant to be limiting, but can include any vulnerable, compromised, visible, exploited, or any other level of security risk.

Although the invention has been illustrated and described herein with reference to a preferred embodiment and a specific example thereof, it will be readily apparent to those of ordinary skill that the art that other embodiments and examples may perform similar functions and/or achieve user experiences. All such equivalent embodiments and examples are within the spirit and scope of the present invention, are contemplated thereby, and are intended to be covered by the following claims.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect. The present disclosure is to be considered as an example of the invention, and is not intended to limit the invention to a specific embodiment illustrated by the FIGURES above or description below.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components. As used herein, the term “and/or” includes any and all combinations of one or more of the associated listed items. As used herein, the term “application” is intended to be interchangeable with the term “invention”, unless context clearly indicates otherwise. As used herein, the term “virtual space” is intended to mean the set of possible user locations, where a location is specified by parameters assigned to each user. These parameters are modifiable by the user, thereby rendering the space navigable.

To aid the Patent Office and any readers of any patent issued on this application in interpreting the claims appended hereto, Applicant that it does not intend any of the claims or claim elements to invoke 35 U.S.C. 112(f) unless the words “means for” or “step for” are explicitly used in the particular claim.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings. In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims. Furthermore, the specification and claims should be read with the understanding that the virtual space, or spaces, and/or the number of participants using the invention simultaneously which are implied or described herein do not limit the scope of the invention or the claims.

What is claimed is:

1. A system for assessing security of network connected things, comprising:
a computer;
a database of vulnerable device types in data communication with said computer;
a plurality of things connected to a network;
a plurality a connection requests sent to said plurality of things by said computer;
a message received by said computer from at least one of said plurality of things in response to the connection request;
software executing on said computer classifying at least one of said things as at least one device type based on said received message; and
software executing on said computer comparing said at least one device type to said vulnerable device types to determine whether the device is vulnerable.

2. The system of claim 1, further comprising an alert generated by said computer based on the determination.

3. The system of claim 2, the alert being transmitted to a third-party computer.

4. The system of claim 3, wherein the alert is transmitted to a company controlling the thing.

5. The system of claim 3, wherein the alert is transmitted to an Internet service provider.

6. The system of claim 3, wherein the alert is transmitted to a DNS authority.

7. The system of claim 3, wherein the alert is transmitted to the manufacturer of the thing.

8. The system of claim 6, wherein a domain name associated with said device is determined by said computer and transmitted as part of the alert.

9. The system of claim 5, wherein, if it is determined that the device is vulnerable, the computer flags the domain for inclusion in a DNS quarantine.

10. The system of claim 1, wherein an IP address is determined for the device.

11. The system of claim 1, where multiple IP addresses are determined for the device.

12. The system of claim 1, wherein the message includes at least one port identification.

13. The system of claim 1, wherein the message is a request header.

14. The system of claim 1, further comprising software executing on said computer that compares protocols identified in the message to identify if a vulnerable device type exists.
